(19) United States
(12) Patent Application Publication
(10) Pub. No.: US 2010/0124220 A1
(43) Pub. Date: May 20, 2010

(54) Method And Systems For Incrementally Resolving A Host Name To A Network Address

(76) Inventor: Robert P. Morris, Raleigh, NC (US)

Correspondence Address: SCENERA RESEARCH, LLC, 111 CORNING RD., SUITE 220, CARY, NC, 27518, US

(21) Appl. No.: 12/272,989

(22) Filed: Nov. 18, 2008

(51) Int. Cl. H04L 12/56

(52) U.S. Cl. 370/389

(57) ABSTRACT

Methods and systems are described for incrementally resolving a host name to a network address. In one aspect, the method includes receiving, by a path node in a network path to a destination node, a packet including a name corresponding to a portion of a network address. The method also includes determining the portion of the network address corresponding to the name. The method further includes determining a network interface of the path node based on the portion of the network address. The method still further includes transmitting the packet via the determined network interface to a next node in the network path to the destination node.

### BACKGROUND

The Domain Name System (DNS) is a hierarchical naming system for computers, services, or any resource participating in the Internet. DNS associates information with domain names assigned to such resources. Further, DNS translates humanly meaningful domain names to the numerical identifiers associated with networking equipment for the purpose of locating and addressing these resources. An often used analogy to explain the Domain Name System is that it serves as the “phone book” for the Internet by translating human-friendly computer hostnames into IP addresses. For example, www.example.com can be translated to 208.77.188.166.

The current Domain Name System performs end-to-end name resolution. That is, given a host name, the DNS resolves the host name to its full network address. This is necessary because only full-network addresses are usable on Transmission Control Protocol (TCP)/Internet Protocol (IP) networks for unicast communication.

### SUMMARY

Methods and systems are described for incrementally resolving a host name to a network address. In one aspect, the method includes receiving, by a path node in a network path to a destination node, a packet including a name corresponding to a portion of a network address. The method also includes determining the portion of the network address corresponding to the name. The method further includes determining a network interface of the path node based on the portion of the network address. The method still further includes transmitting the packet via the determined network interface to a next node in the network path to the destination node.

According to another aspect, a system for incrementally resolving a host name to a network address is described. The system includes a packet detector component, in a path node in a network path to a destination node, configured to receive a packet including a name corresponding to a portion of a network address. The system further includes a resolver component configured to determine the portion of the network address corresponding to the name. The system still further includes a forwarding engine component configured to determine a network interface of the path node based on the portion of the network address. The system also includes a network interface component configured to transmit the packet via the determined network interface to a next node in the network path to the destination node.

According to another aspect, a computer readable medium storing a computer program, executable by a machine, for incrementally resolving a host name to a network address is described. The computer program includes executable instructions for receiving, by a path node in a network path to a destination node, a packet including a name corresponding to a portion of a network address. The computer program further includes executable instructions for determining the portion of the network address corresponding to the name. The computer program still further includes executable instructions for determining a network interface of the path node based on the portion of the network address. The computer program also includes executable instructions for transmitting the packet via the determined network interface to a next node in the network path to the destination node.

### BRIEF DESCRIPTION OF THE DRAWINGS

Objects and advantages of the present invention will become apparent to those skilled in the art upon reading this description in conjunction with the accompanying drawings, in which like reference numerals have been used to designate like or analogous elements, and in which:

FIG. 1 is a flow diagram illustrating a method for incrementally resolving a host name to a network address according to an aspect of the subject matter described herein;

FIG. 2 is a block diagram illustrating a system for incrementally resolving a host name to a network address according to another aspect of the subject matter described herein;

FIG. 3 is a block diagram illustrating an exemplary execution environment for incrementally resolving a host name to a network address according to another aspect of the subject matter described herein;

FIG. 4 is a message flow diagram illustrating an exemplary message flow a method for incrementally resolving a host name to a network address according to an aspect of the subject matter described herein;

FIG. 5 is a block diagram illustrating an exemplary system for incrementally resolving a host name to a network address according to another aspect of the subject matter described herein;

FIG. 6 illustrates an exemplary schema for a network address according to another aspect of the subject matter described herein;

FIG. 7 illustrates an exemplary packet configured according an IP packet schema according to another aspect of the subject matter described herein; and

FIG. 8 illustrates an exemplary schema for a network address according to another aspect of the subject matter described herein.

### DETAILED DESCRIPTION

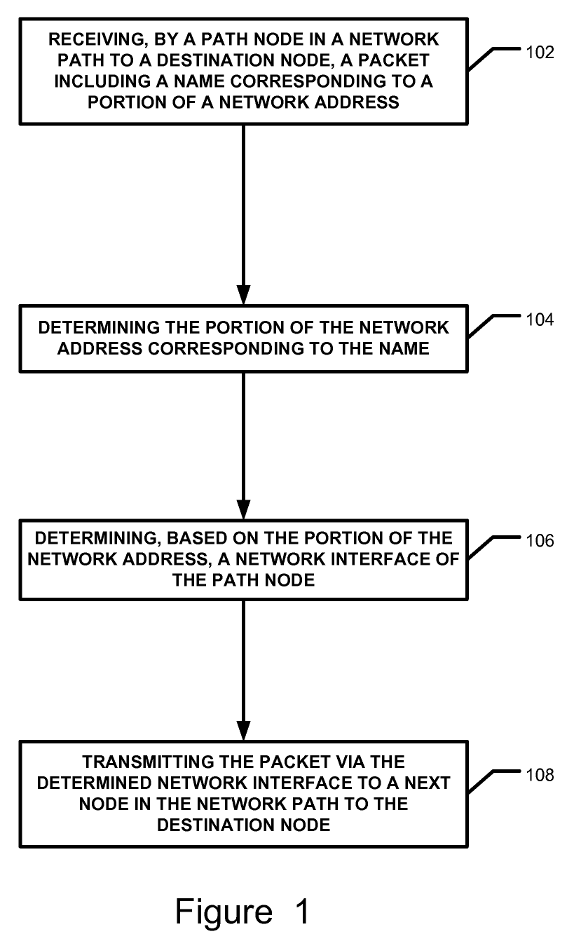

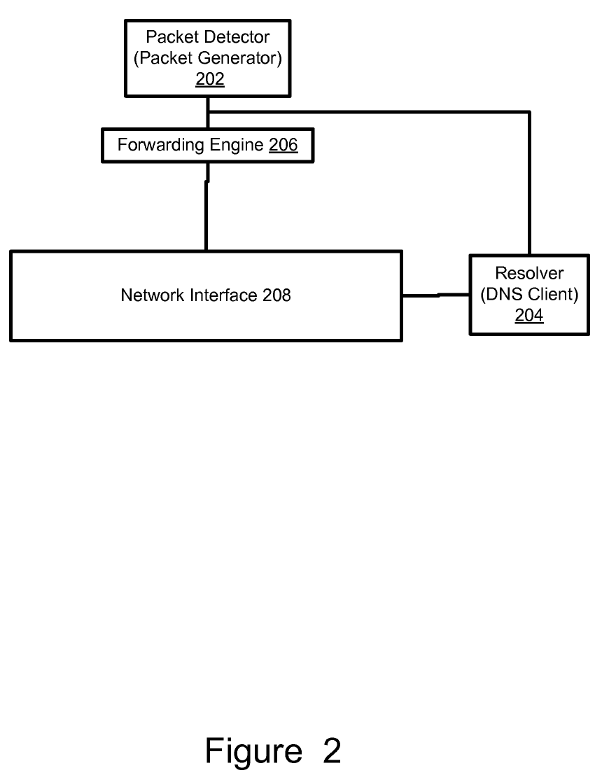

FIG. 1 is a flow diagram illustrating a method for incrementally resolving a host name to a network address according to an exemplary embodiment of the subject matter described herein. FIG. 2 is a block diagram illustrating a system for incrementally resolving a host name to a network address according to another exemplary embodiment of the subject matter described herein. The method illustrated in FIG. 1 can be carried out by, for example, some or all of the components illustrated in the exemplary system of FIG. 2.

With reference to FIG. 1, in block 102 a path node in a network path to a destination node receives a packet including a name corresponding to a portion of a network address. Accordingly, a system for incrementally resolving a host name to a network address includes means for receiving, by a path node in a network path to a destination node, a packet including a name corresponding to a portion of a network address. For example, as illustrated in FIG. 2, a packet detector component 202, in a path node in a network path to a destination node, is configured to receive a packet including a name corresponding to a portion of a network address.

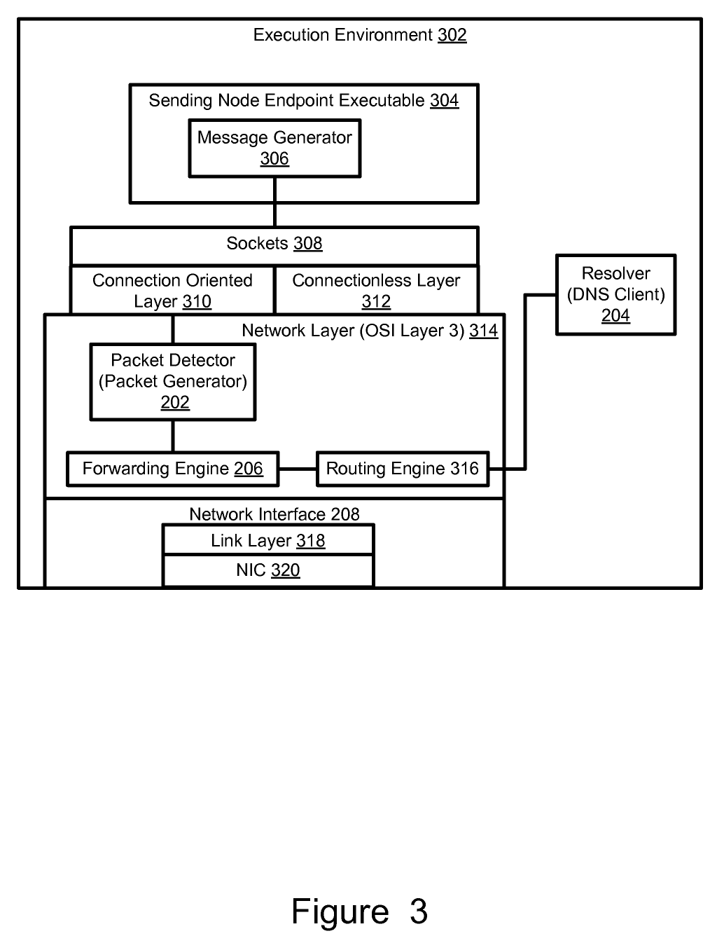

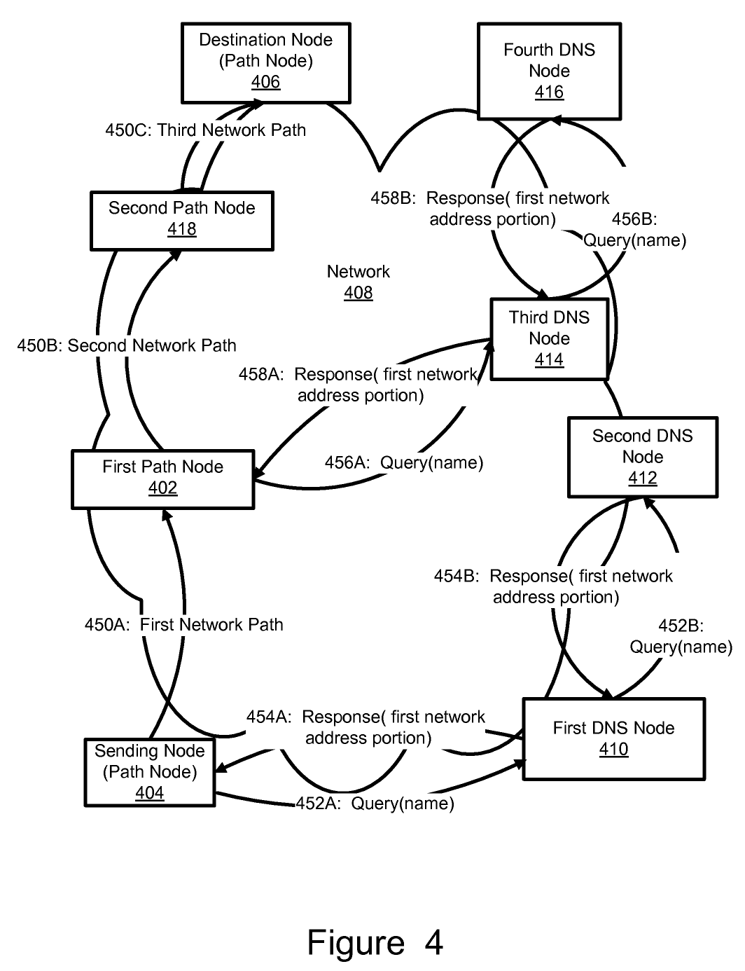

FIG. 2 illustrates the packet detector component 202 configured to operate in a node configured to receive a packet. The received packet includes a name corresponding to a portion of a network address. The components illustrated in FIG. 2 can be adapted for performing the method illustrated in FIG. 1 in a number of execution environments, including an exemplary execution environment 302 provided by the components illustrated in FIG. 3. An execution environment can be hosted by a node and/or can be hosted by multiple nodes as in a distributed execution environment. For example, referring to FIG. 4, a first node path node 402, a sending node 404, or any other node can be configured to provide the execution environment 302 adapted for supporting the operation of the components illustrated in FIG. 2.

An exemplary execution environment can include a variety of components, including, but not limited to, memory for storing components and an instruction processing component, such as processor and/or a digital signal processor (DSP), for processing instructions and any data associated with the operation of the components such as the components illustrated in FIG. 2. The components illustrated in FIG. 2 and functionally analogous arrangements of components each can require at least one of additional hardware and software subsystems according to their particular operational requirements.

FIG. 4 illustrates a message flow diagram illustrating the first path node 402 in a network path 450 including a first network path 450A, a second network path 450B, and a third network path 450C, through a network 408 to a destination node 406. The first path node 402 is included in both the first network path 450A and the second network path 450B. A packet can be received by a path node, such as the first path node 402. The packet can be received by the sending node 404, hosting a packet detector component 202 configured to receive the packet including a name corresponding to a portion of a network address. The network address can be in a network address space of an internet, such as the internet protocol (IP) network address space. As used herein, a name can be any identifier usable for referencing and/or generating a corresponding network address portion. For example, the name can be any representation of the corresponding portion of the network address other than the portion of the network address itself. The name can also directly identify the corresponding portion of the network address.

In another aspect, the packet detector component 202 can be configured to receive the packet including a first header including type bits indicating that a name is included in the packet. In another aspect, the packet detector component 202 can be configured to receive the packet including a name header including the name. In another aspect, the packet detector component 202 can be configured to receive the packet including a payload area including the name.

FIG. 3 illustrates the components of FIG. 2 including the packet detector component 202 adapted for operation in the execution environment 302. The execution environment 302 can be hosted by the sending node 404, illustrated in FIG. 4. The execution environment 302 includes a sending node endpoint executable (SNEE) 304. The SNEE 304 can include a message generator component 306 configured to generate a message based on information including a network identifier of a destination node, such as the destination node 406 illustrated in FIG. 4. The network identifier can be a name or other alias associated with at least a portion of a network address of the destination node 406. The message generator component 306 can provide data and the network identifier including the name to a sockets component 308 layer or any other suitable stack interface layer for sending data to a network stack for transmitting over a network, such as the network 408.

As FIG. 3 illustrates, the sockets component 308 can determine the type of protocol indicated for data transmission. A connection oriented layer 310, such as a TCP protocol layer, can be provided in the execution environment 302 for sending data via a connection oriented protocol. A connectionless layer 312, such as a User Datagram Protocol (UDP) layer, can be provided for sending data via a datagram. In FIG. 3, the sockets component 308 can determine the type of protocol with which to transmit the received data. The received data and the network identifier of the destination node 406 can be provided to the connection oriented layer 310 as shown, or can be provided to another protocol layer such as the connectionless layer 312 or to a network layer 314 illustrated, such as an IP protocol layer.

The data received by the network layer 314 can include additional data added by an upper layer, such as the connection oriented layer 310. The data can be provided in a variety of forms, including at least one of a header of a packet, a trailer of a packet, and a stream of data according to the protocol supported by the connection oriented layer 310. In processing the received data including the network identifier, the network layer 314 can provide the data and the network identifier received by the packet detector component 202. The packet detector component 202 can be configured to package the data into packets and include the name corresponding to a portion of the network address of the destination node 406 in the generated packet. The generated packet can be received by a portion of the packet detector component 202. The portion of the packet detector component 202 that receives the packet including the name can be configured to provide the packet to another component for further processing, such as a forwarding engine component 206, described in greater detail below.

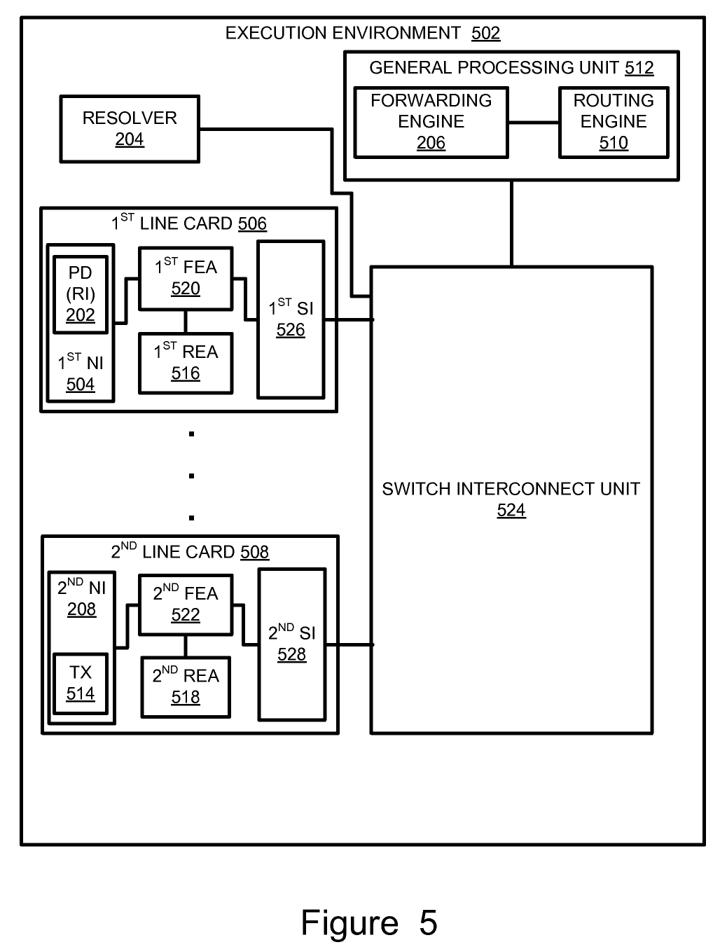

FIG. 5 illustrates a collection of components providing an exemplary execution environment 502. The components include a packet detector component 202 adapted for operation as a receiving interface of a first line card 506 in the execution environment 502. The execution environment 502 can be hosted, for example, by the first path node 402.

The first path node 402 can be any node configured to relay a packet along a network path and/or between two network paths. Such a node can be a router, a switch, or any other node configured to relay a packet. The packet detector 202 is illustrated, according to an aspect, in FIG. 5 as a receiving interface included in a first network interface 504 operatively coupled to a portion of the network 408 including the first network path 450A. The network interface 504 can include a transmitting interface (TI) operatively coupled to the same portion of the network as the packet detector component 202. The packet can be received from the sending node 404 configured to send data via the network 408 to the destination node 406 via a path 450 including a network path 450A from the sending node 404 to the first path node 402. The first path node 402, as described below, can be configured to relay the received packet along a network path 450B (also included the path 450) to the destination node 406.

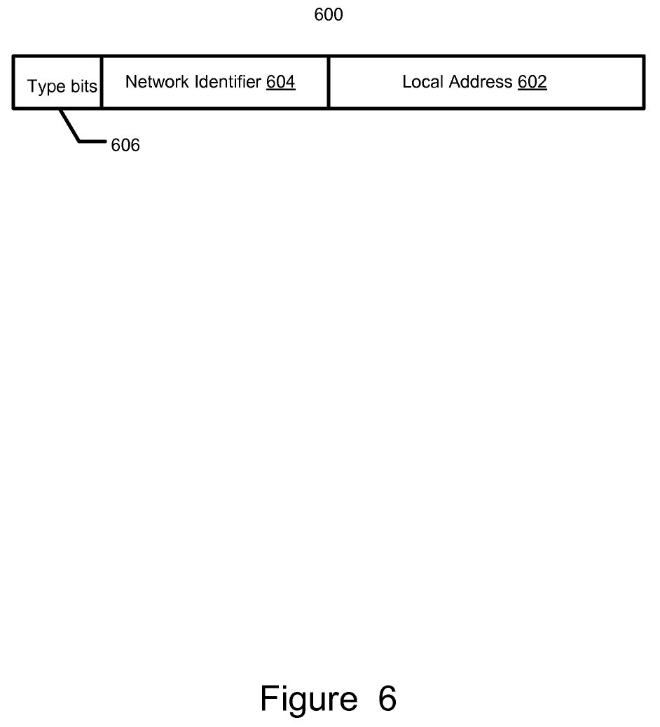

The packets discussed above can have an associated packet type. Exemplary packet types can include, but are not limited to, unicast packets, broadcast packets, and multicast packets associated with one or more destination nodes. FIG. 6 illustrates a high level schema for storing and/or transmitting a network address 600, such as an IPv4 and/or an IPv6 address. A local address location 602 can include an identifier identifying a node in a particular portion of a network. A portion of a network can be a subnet and/or a network naming domain. A network identifier location 604 can include a portion of the network address identifying the portion of the network in which the local address applies. A type bits location 606 in an IPv4 address can include a number (having a corresponding bit pattern) that can specify an address class that defines the internal structure of a network address. For example, the Internet Engineering Task Force (IETF) Request for Comments (RFC) 796 describes numbers that can be included in the type bits location 606 specifying that the address class of the network address 600 is class A, class B, or class C. Classes A, B, and C do not constitute an exhaustive list of network address classes. RFC 796 defines the class A address to have a 7-bit network identifier and a 24-bit local address; a class B address is defined to have a 14-bit network identifier and a 16-bit local address, and a class C address is defined to have a 21-bit network identifier and an 8-bit local address.

In an IPv6 address a type bits location 606 can identify whether a network address is a unicast packet including whether it's a link local unicast address, a site local unicast address and/or an outside scope unicast address. The type bits in an IPv6 address define additional types and a number of values for the type bits are currently undefined with respect to their meaning. A description of the use of the type bits in an IPv6 address is included in RFC 3513. IPv6 addresses have a hierarchical internal structure as do IPv4 addresses. Knowledge of, and thus detection of, the internal structure of an IPv6 address can vary from node to node as described in RFC 3513

Nodes can be configured to know only what is necessary about the internal structure of an address for routing purposes. A node including the packet detector component 202 can be configured to receive a packet including a name corresponding to at least a portion of a network address, such as the network address of the destination node. The node can be configured to then transmit the packet along a network path for delivery to the destination node without knowledge of the internal structure of the network address and without detecting the name and its correspondence to at least a portion of the network address.

A name can correspond to a portion of a network address according to a specified structure of the network address. For example, in an IPv4 network address a first name can be included in a packet corresponding to a network identifier 604 according to an address class indicated in the type bits 606 and/or a second name can be included in the packet corresponding to the local address 602 according to the class specified in the type bits 606. In general, a name can be included in a packet corresponding to one or more hierarchical portions of a network address.

A name can be included in a packet in various ways. In one aspect, a pattern of bits in the type bits 606 can be defined to indicate that a name is included in a packet corresponding to a particular portion or to each portion of the network address according to a given internal structure of the network address. A particular portion of the type bits 606 can be defined to indicate that a name for the network identifier or for a specific portion of the network identifier is included in a packet. Analogously, a particular portion of the type bits 606 can be defined to indicate that a name for the local address or for a specific portion of the local address is included in a packet.

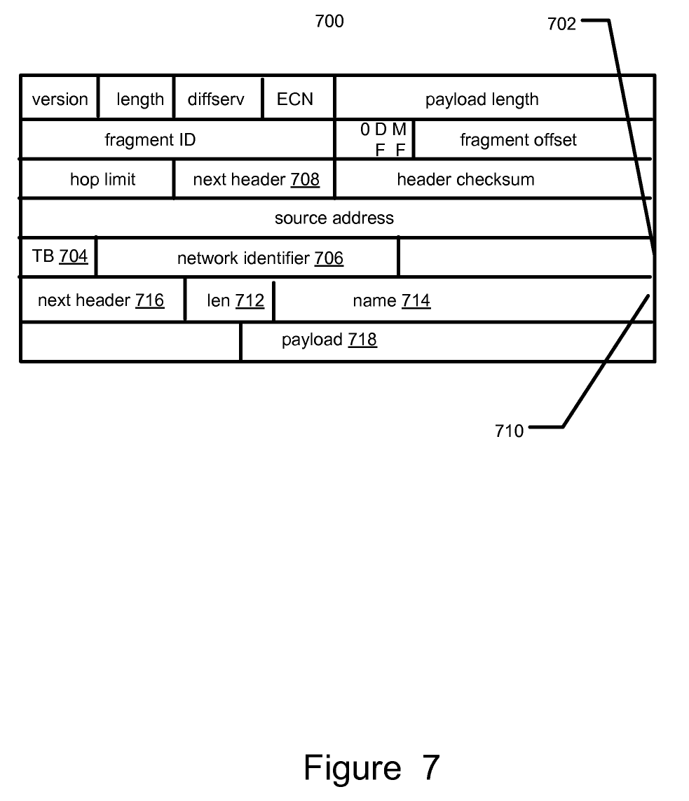

FIG. 7 illustrates a packet 700 configured according an IP packet schema defining a location for including a destination address 702 including type bits 704 defined to indicate that a particular network identifier portion 706 of the destination address is represented by a name included in the packet 700. A next header 708 can include a value defined to indicate the presence of a name header 710 region of the packet 700. The name header 710 is illustrated including a name region 714 for storing a name or a reference to a name corresponding to a portion of the network address and a length region represented by length 712 for storing data indicating a length value of the name region 714 and/or length of the name in the name in the name region 714. The name header 710 can also include an area including a next header 716 indicating a region of the packet following the name header 710 such as a payload 718 area. The payload area can include information associated with a high layer protocol. For example, a next header following a name header can be a TCP header followed by a payload area of a TCP message.

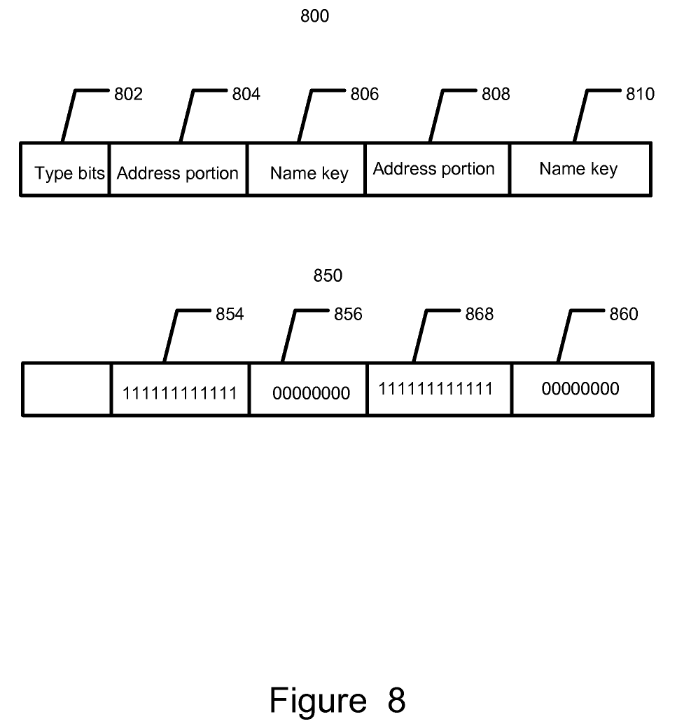

Referring now to FIG. 8, a network address 800 is illustrated including a type bits area 802, a first address portion 804, a first name key portion 806, a second address portion 808, and a second name key portion 810. One or more portions of a structured address can be included as an address portion or can be represented by a name. A name portion can be distinguished from an address portion based on the presence of a header as describe above with respect to FIG. 7. Alternatively, rather than the type bits 802 indicating a portion of the network address 800 corresponding to a name, a header can identify the portion of the address corresponding to the name and include or reference a name corresponding to the identified portion of the network address.

Alternatively a mask, as illustrated in FIG. 8 as an exemplary mask 850, can be provided to determine whether a portion of a network address is present in a network address in a network address area or is represented by a name locatable within a packet including the network address area. In FIG. 8, the exemplary mask 850 includes bits with a value of ‘1’ to indicate a corresponding bit in the network address area of the packet includes a bit that is a network address bit. The first address portion 804 and the second address portion 808 illustrate network address portions in the network address that each include a portion of the network address as indicated by the ‘1’ values stored in a first mask portion 854 and a second mask portion 858 illustrated in the mask 850. A ‘0’ bit in the mask 850 can indicate that a corresponding bit in a network address location in the packet is a bit in a portion of a network address corresponding to a name included in the packet. The first name portion 806 and the second name portion 810 illustrate portions of the network address 800 represented by names included in a packet addressed to and/or from a node having the network address 800 as indicated by the ‘0’ values stored in a third mask portion 856 and a fourth mask portion 860 illustrated in the mask 850.

According to an aspect, a value can be included in the location of the network address portion having a corresponding name in the packet. The value can be a key, referred to herein as a name key, that is usable for identifying a location in the packet including the corresponding name or including a reference to the corresponding name. Additionally, a header can be provided in a packet that includes one or more names each corresponding to a portion of a network address. A name key for the portion can be an index into the header of names for locating a name corresponding to the portion of the network address storing the name key.

For routing a packet, a particular of node can have no knowledge or some knowledge of at least a portion of the internal structure of a packet as described in RFC 3513. This remains true for nodes receiving packets including a name corresponding to a portion of a network address. If a packet includes a portion of a network address required by a node to route the node to a next node or along a next hop, the node need not use a name corresponding to another portion of the network node included in the packet. The node need not have knowledge of the name. A node can be configured with one or more masks each corresponding to a network address based on attribute of the network address such as its class. Alternatively, the node can be configured with only a portion of each of the one or more masks needed by the node for routing a network address based on an attribute of the network address. A configured mask can be stored locally, remotely, and/or determined based on evaluating a policy. Alternatively or additionally, at least a portion of a mask can be included in the packet and/or in a previously associated packet such a first packet of a TCP connection for use in detecting a portion of a network address in a received packet that has a corresponding name included in the packet.

Returning to FIG. 1, in block 104 the portion of the network address corresponding to the name is determined. Accordingly, a system for incrementally resolving a host name to a network address includes means for determining the portion of the network address corresponding to the name. For example, as illustrated in FIG. 2, a resolver component 204 is configured to determine the portion of the network address corresponding to the name.

FIGS. 3 illustrates the resolver component 204 adapted for operation in the execution environment 302. As described above, the resolver component 204 is configured to determine the portion of the network address corresponding to the name. The packet detector component 202 can be configured to detect a packet including the name corresponding to the portion of the network address.

In another aspect, the resolver component 204 can be configured to detect the name in the packet, and in response to detecting the name, identify the position of the corresponding portion of the network address within the network address. In another aspect, the resolver component 204 can be configured to detect the name in the packet based on a packet schema. In another aspect, the resolver component 204 can be configured to query a network directory service node configured to resolve the name to the portion of the network address.

In response to detecting the name, the packet detector component 202 can provide the name and optionally identify the position of the name within a complete network name and/or identify the position of the corresponding portion of the network address within the network address to the resolver component 204. Alternatively, a forwarding engine component 206 can be configured to receive the network address information in the packet from the packet detector component 202. The forwarding engine component 206 can determine that that at least a portion of the network address corresponds to one or more names. In response to determining the correspondence the forwarding engine component 206 interoperating with the packet detector component 202 can provide to the resolver component 204 the name and optionally identify the position of the name within the network name and/or optionally identify the position of the corresponding portion of the network address within the network address.

The resolver component 204 can be configured to generate a query including the name and optionally position of one or more of the name in a network name and the portion of the network address in the network address. For example, the name “placid.nc.sceneralabs.com” can be received by the packet detector component 202 operating the execution environment 302 illustrated in FIG. 3. The sending node 404 in FIG. 4 can provide the execution environment 302. The SNEE 304 can be prevented from detecting at least a portion of the network address of the destination node 406.

As described above, a network identifier including a first name, “sceneralabs.com”, can be received by the packet detector component 202 from a higher protocol layer, such as the connection oriented layer 310 and the connectionless layer 312 illustrated in FIG. 3. The higher protocol layer can receive at least a portion of the data and at least the name portion of the network identifier from the message generator component 306 of the SNEE 304 via a protocol layer interfaces, such as the sockets component 308. The name “sceneralabs.com” can correspond to a first network portion or top-level domain portion of a network address of the destination node 406. The name portion, “sceneralabs.com”, can be referred to as a root-domain name. A resolver component 204 is illustrated in FIG. 4 as being adapted for operation in the execution environment 302 of the sending node 404. For example, the root-domain name, “sceneralabs.com” can be resolved to a first network address portion, 21.192, identifying an IPv4 subnet 21.192.0.0/10. The resolver component 204 can generate a query message including the name to send to a network directory service (NDS) node to be resolved to the corresponding portion of the network address.

FIG. 4 illustrates the sending node 404 sending a query message 452A including the name to a first DNS node 410. The name, “sceneralabs.com”, identifies a root-domain portion of a DNS name. The identified root-domain based on the structure of the DNS naming system includes the name of the destination node 406. The first DNS node 410 can resolve the root-domain name to the first portion of a network address identifying a subnet including the naming domain. In some circumstances, more than one subnet can be identified of which one includes the destination node. Resolving can include sending the query message 452A to first DNS node 410 for processing. The first DNS node 410 can identify a subnet including network interfaces of nodes with names in the root-domain name. For example, the first DNS node 410 can represent at least a portion of the domain (including one or more subdomains) identified by the root-domain name. The first DNS node 410 can generate and transmit a response message 454A to the sending node 404 identifying a network address portion corresponding to the root-domain name. The root-domain name portion, as described in application Ser. No. 11/962,285 (Attorney Docket No 1509/US) filed on Dec. 21, 2007, entitled “METHODS AND SYSTEMS FOR SENDING INFORMATION TO A ZONE INCLUDED IN AN INTERNET NETWORK” which is herein incorporated by reference, can have inside scope and/or outside scope.

Alternatively or additionally, the first DNS node 410 can route the query message 452A through the DNS to a second DNS node 412 representing at least a portion of the domain identified by the root-domain name. The routing of the message 452A through the DNS is illustrated in FIG. 4 as a query message 452B sent from the first DNS node 410 and received by the second DNS node 412. The second DNS node 412 can identify a subnet including network addresses of nodes mapped to the domain identified by the root-domain name “sceneralabs.com”. The network address portion identifying the subnet can be sent in a response message illustrated by a response message 454B to the first DNS node 410. The first DNS node 410 can include the subnet identifier portion of the network address in the response message 454A. The query message 452A and corresponding response 454A can represent more than one request response exchange between the sending node 404 and the first DNS node 410. The query 452B and its corresponding 454B can also represent one or more request-response message pairs exchanged between the first DNS node 410 and one or more second DNS nodes. Further a single request-response pair represented by the query 452B and its corresponding response 454B can represent one or more query messages and on or more response messages each transmitted over a portion of a path traversed by the query and a path traversed by the response in communications among the nodes of the DNS.

A DNS node represents a naming domain if it maintains a record associating a name in the naming domain with at least a portion of a network address. DNS nodes representing a domain include authoritative nodes for the domain, slave/caching nodes, and/or any DNS node having a cached record associating a name in the domain with at least a portion of a network address.

In another example, a packet received by the packet detector component 202 can include a name that can identify a subdomain of a root-domain. In the DNS name space, “nc”, in the node name “placid.nc.sceneralabs.com” can be received by the packet detector component 202 along with data to be transmitted to a destination node. For example, a destination can be included in a site scope along with the sending node. The packet detector component 202 can receive a local address portion of the destination node's IPv6 network address, such as the destination node's media access control (MAC) address, providing a link local and/or a subnet local unicast address for the destination node with a subnet included in the “nc” naming subdomain in the naming domain of “sceneralabs.com”.

Neither the root-domain nor the network identifier portion corresponding to the root-domain name is required to route a packet from the sending node to the destination node. The name, “nc”, has both inside and outside scope and its scope can be identified based on a mask identifying a network identifier portion of the network address that corresponds to a subnet identifying a scope within which a MAC address can identify the destination node. For example, the mask in hexadecimal format, “00 00 00 00 00 00 06 FF 00 00 00 00 00 00 00 00”, indicates the name corresponds to bits 64 through 73 of the 128-bit address correspond to the name “west” locatable in a header area of an IP packet generated by the packet detector component 202 based on data and an network identifier including the MAC address of the destination node and the DNS subdomain name, “nc”. Bits in the mask are numbered 0-127 counting right to left in this example.

According to another aspect, the name, “nc” can be included in a packet received by the packet detector component 202 operating in the execution environment 502 as illustrated in FIG. 5. The execution environment 502 can be provided by the first path node 402 illustrated in FIG. 4 operating as a node configured to relay received data along a path to a destination node, such as the destination node 406. For example, the first path node 402 can be a router, a switch, or any other node configured to relay received data.

The received packet can include a header, a mask, and/or a type bit pattern (described above), and can be formatted according to any suitable packet schema. The packet detector component 202 can be configured to process the packet according a particular packet schema in order to detect a portion of a network address corresponding to the name, “nc”. For example, the packet can include a mask for an IPv4 address with the bit pattern expressed as a hexadecimal number 00 0F F0 00. “nc” can be a portion of a DNS name representing a naming domain included in a higher level naming domain. The packet received by the packet detector component 202 as a result of routing the packet based the 12 high order address bits as, for example, an outside scope unicast address, such as 21.192.0.0, an/or a portion of the 12 high bits such as in the address 0.192.0.0 having both an inside scope and an outside scope. The name “nc” can be processed as a DNS name with both an inside and an outside scope. The first path node 402 represents the network identified by outside scope address of the at least a portion of the 12 high order bits of the network address.

According to an aspect, a name corresponding to a location of a destination node can be included in the packet in a network having a network address space including geospatial network addresses. For example, the name can be a geospatial name identifying a name geospatial region. In another aspect, the geospatial name is associated with a domain having a corresponding domain geospatial region at least partially present in the name geospatial region. A portion of the name can be identified with a geospatial scope. Based on the geospatial scope of the name, a corresponding portion of a geospatial network address can be identified that matches and/or can be included in a geospatial region identified by the scope and a current location of the node receiving the packet including the name.

The first path node 402 can be a border node or gateway for the portion of the network identified by the root-domain name and the corresponding 12 high order bits of the network address. As with the sending node 404, FIG. 5 illustrates a resolver component 204 operating in the execution environment 502 of the first path node 402. The packet detector component 202 operating in the first line card 506 can provide the name, “nc”, for receiving by the resolver component 204. The resolver component 204 can also receive portion information identifying the corresponding area or bits of the network address that include the portion of the network address corresponding to the name, “nc”. The resolver component 204 can generate a query message including the name, “nc”, to send to a network directory service (NDS) node.

FIG. 4 illustrates the first path node 402 sending a query message 456A including the name, “nc”, to a third DNS node 414 via a line card included the first path node. FIG. 5 illustrates a first line card 506 and a second line card 508 operating in the first path node 402. A line card, such as the first line card 506 and the second line card 508, can be configured to transmit a query via a portion of the network 408. The line card transmitting the query can be based on an identity of a line card including a packet detector component receiving the packet. The name, “nc”, can identify a subdomain represented by the third DNS node 414 and/or a subdomain included in a subdomain represented by the third DNS node 414. The naming subdomain based on the structure of the DNS naming system includes the name of the destination node 406. The third DNS node 414 can resolve the subdomain name, “nc”, to the second portion of a network address identifying a subnet within the scope of a network served by the first path node 402 including the naming subdomain, “nc”.

More than one subnet can be identified by the name, wherein one of the identified subnets includes the destination node. Resolving can include sending the query message 456A to the third DNS node 414 for processing. The third DNS node 414 can identify a subnet including network interfaces of nodes with names in the subdomain, “nc”. For example, the third DNS node 414 can represent at least a portion of the “nc” subdomain (including one or more subdomains) identified by the “nc” subdomain name. The third DNS node 414 can generate and transmit a response message 458A to the first path node 402 identifying a network address portion corresponding to a subnet identified by the “nc” subdomain name that can have both inside and outside scope.

Further, the third DNS node 414 can route the query message 456A through the DNS to a fourth DNS node 416 representing at least a portion of the subdomain identified by the “nc” name. The routing of the message 456A through the DNS is illustrated in FIG. 4 as a query message 456B sent from the third DNS node 414 and received by the fourth DNS node 416. The fourth DNS node 416 can identify a subnet including network addresses of nodes mapped to the “nc” subdomain”. The network address portion identifying the subnet can be sent in a response message illustrated by response message 458B to the third DNS node 414. The third DNS node 414 can include the subnet identifier portion of the network address in the response message 456A. The query message 456A and the corresponding response 458A can represent more than one request response exchange between the first path node 402 and the third DNS node 414. The query 456B and its corresponding 458B can also represent one or more request-response message pairs exchanged between the third DNS node 414 and one or more second DNS nodes. Further a single request-response pair represented by the query 456B and its corresponding response 458B can represent one or more query messages and one or more response messages each transmitted over a portion of a path traversed by the query and a path traversed by the response in the nodes of the DNS. As the scope of a name corresponding to a portion of a network address becomes increasingly restricted, the need and the length of the path of the query message 456B and response 458B decreases.

For example, the subdomain name, “nc”, corresponding to the portion of an IPv4 network address identified by the hexadecimal mask 00 0F F0 00, can be resolved to a second network address portion, 8.48, identifying an IPv4 subnet 0.8.48.0/20 in a portion of a network with a scope served by the first path node 402. If the packet received by the first path node 402 corresponds to the packet send by the sending node 404, the address 21.200.48.0/20 has been identified collectively by the nodes in the path 450A illustrated in FIG. 4.

The same process described above with respect to the first path node 402 can be repeated at subsequent nodes such as the second path node 418 in a path 450 to the destination node 406 from the first path node 402. The second path node 418 can be a border node or gateway router for the domain identified by nc.sceneralabs.com. The second path node 418 can identify the name, “placid”, corresponding to a local address portion of a network address when the name, “placid” is included in the received packet. The second path node 418 can resolve this name as a local name as processed by DNS nodes representing a domain local to the DNS nodes. The resolving DNS node (not shown) can return the complete network address of the destination node or return a scoped address, such as a site-local, subnet local, or link-local network address. If the network address portion corresponding to the name “placid” is included in the packet, as for example, a MAC address portion of the network address, the second router can route the packet as routers are currently configured to route packets.

According to an aspect, a directory service node can be required to relay a query to one or more other directory services nodes as exemplified by the DNS based scenarios. Note that the depth of each query can be shallower than the current DNS end-to-end resolution. Using a name to represent a portion of a network address in a packet can produce a system where end-to-end resolution need never be performed. In fact, the network directory system used need not be integrated as the current DNS. Each naming scope can provide its own directory system that need not communicate with directory systems of other network scopes. Further, once a packet has been received by a node serving a scope including the destination address each name can be resolved with single query to a single network directory service.

A scoped region corresponding to a network directory system serving the scoped region can be defined to be small enough that network nodes in serving the scoped region can maintain an entire directory for the scoped region. The directory can be authoritative or not authoritative. A routing table can be generated based on the mappings in the directory service and the topology of the scoped region. In this case, a name can be resolved to a portion of a network address and/or a link layer address corresponding to a next hop by a routing table lookup. Policy based routing protocols can be based on the name to address mappings of the nodes in a particular scoped region of a network. The result can be a network where network name resolution is not required by a sending node in order to send a message. Network name resolution can occur when required for building and/or updating a routing table and/or one or more routing policies.

Returning to FIG. 1, in block 106 a network interface of the path node is determined based on the portion of the network address. Accordingly, a system for incrementally resolving a host name to a network address includes means for determining based on the portion of the network address a network interface of the path node. For example, as illustrated in FIG. 2, a forwarding engine component 206 is configured to determine based on the portion of the network address a network interface of the path node.

The portion of the network address determined by the resolver component 204 based on the corresponding name included in the received packet can be returned to the packet detector component 202. The packet detector component 202 can provide at least a portion of the network address including the determined portion to the forwarding engine component 206 to determine a network interface for transmitting the packet. The determined network interface is in the network path to the destination node.

In FIG. 3, the forwarding engine component 206 is illustrated as being adapted for operation within the execution environment 302. For example, the execution environment 302 can be provided by the sending node 404 (a path node) or any of the other nodes illustrated in FIG. 4. The forwarding engine component 206 can be configured to determine the network interface by interoperating with a routing engine component 316. The routing engine component 316 can be configured to evaluate a policy and/or to maintain a routing table. The policy, for example, can be a value that identifies a gateway node (not shown) in the network path from the sending node to all nodes outside a local scope of the sending node 404. When the routing engine component 316 is configured to evaluate a policy, the policy can be based on any suitable information including path length, path energy expenditure and effective data rate information, a performance metric, a security metric or any other metric. Determining routing information can include performing a routing policy operation on a routing policy. For example, the routing engine component 316 can be configured to perform a routing policy operation on a routing policy based on a determined energy metric to determine routing information. A routing policy operation can include an evaluation of the routing policy.

Further, a routing table can include associations between network interfaces or addresses of nodes in respective paths that include each network interface and at least portions of network addresses. A routing table can be based on any suitable information including path length, path energy expenditure and effective data rate information, a performance metric, a security metric, or any other metric. According to an aspect, at least a portion of a routing table can be specified by a user or an external application. Routing table creation can be based on a routing protocol(s) supported by the node receiving the packet including the name corresponding to a portion of the network address. The node can support routing protocols including a link-state protocol, a distance vector protocol, a path vector protocol, and/or a label switching protocol.

Maintaining a routing table can include performing a routing table operation. A routing table operation can include a routing table lookup. Further, a routing table operation can include any operation for maintaining the routing table, such as updating the routing table. A routing table includes routing information. A lookup to the routing table can return routing information including information identifying the network interface in the path to the destination node 406. The network interface can be identified based on a path specification, a subnet identifier, a network and/or address of next hop node determined based on a routing table lookup and/or a policy evaluation.

The forwarding engine component 206 can be configured to receive the routing information provided by the routing engine component 316. The forwarding engine component 206 can be configured to identify a network interface, such as the network interface 208. The network interface 208 illustrated in FIG. 3 includes a link layer 318 and a network interface card (NIC) 320 such as an Ethernet adapter and/or a wireless network adapter. A Network Interface Card (NIC) 320 can include at least a portion of the link layer 318.

In the network 408 illustrated in FIG. 4, the sending node 404 can be configured to provide the execution environment 302 and can include the NIC 320 operatively coupled to a portion of the network 408 including one more paths to the destination node. For example, the network can include the network path 450A from the network interface of the sending node 404 to the packet detector component 202 of the first path node 402 providing the execution environment 502.

As discussed above, more than one path can exist in a network for transmitting a packet to a destination node. The sending node 404 can include one or more network interfaces each for transmitting a packet via one or more of a plurality of paths. The forwarding engine component 206 can be configured to identify a network interface included in the more than one network interfaces for transmitting the packet via an optimal path according to a particular configuration. Optimal can be defined by a policy evaluated and/or a lookup operation on a particular routing table.

In FIG. 5 the forwarding engine component 206 is illustrated adapted for operation within the execution environment 502. The execution environment 502 can be provided by the first path node 402 illustrated in FIG. 4. The second path node 418 can provide an execution environment including the components of FIG. 5 or an analogous arrangement of components configured to perform the method in FIG. 1. The forwarding engine component 206 can determine the network interface by interoperating with a routing engine component 510 included in a general processing unit 512. The routing engine component 510 can be configured to evaluate a policy and/or to maintain a routing table. The policy, for example, can be a value that identifies a gateway node (not shown) in the network path from the sending node to all nodes outside a local scope of the first path node 402.

In another aspect as described above, determining routing information includes performing a routing policy operation on a routing policy. For example, the routing engine component 510 can be configured to perform a routing policy operation on a routing policy based on a determined energy metric to determine routing information.

The forwarding engine component 206 can receive the routing information provided by the routing engine component 510. The forwarding engine component 206 can be configured to identify a network interface, such as the second network interface 208. The second network interface 208 includes a transmitter (TX) 514 operatively coupled to the network 408 to transmit data via the network 408. The second network interface 208 is included in the second line card 508 as described above.

In the network 408 illustrated in FIG. 4, the first path node 402 can be configured to provide the execution environment 502 and can include the packet detector component 202 in the first line card 506 operatively coupled to a portion of the network 408 including one more paths to the destination node, such as the network path 450 including the network path 450A from the network interface 208 of the sending node 404 to the packet detector component 202 of the first path node 402 providing the execution environment 502. Also as illustrated in FIG. 4 and in FIG. 5, the first path node 402 can include the second network interface card 208 including the transmitter (TX) 514 operatively coupled to a portion of the network 408 including one or more paths to the destination node 406, such as the network path 450 and including the network path 450B from the network interface 208 of the first path node 402 to a second path node 418 in the network path 450 to the destination node 406.

According to an aspect, a node hosting the components illustrated in FIG. 5, such as the first path node 402 and/or the second path node 418, can include additional components for enhancing its operation. For example, each network interface can be included in a line card. A first network interface 504 is illustrated included in the first line card 506, and the second network interface 208 is illustrated included in a second line card 508. Each line card of the hosting node including the first line card 506 and the second line card 508, can include a routing engine component agent (REA). A REA can be provided for distributing the operation of the routing engine component 510, offloading the work of the routing engine component 510, and reducing traffic flow between the line cards and the general processing unit 512. A REA can operate as a cache storing a portion of the routing table maintained by the routing engine component 510 and performing lookups locally in the including line card. In FIG. 5, a first routing engine agent (REA) 516 is illustrated in the first line card 506 and a second REA 518 is illustrated in the second line card 508.

FIG. 5 illustrates two line cards of a path node hosting the components illustrated in FIG. 5, including the first line card 506 and the second line card 508, including a forwarding engine agent (FEA), illustrated as a first FEA 520 in the first line card 506 and a second FEA 522 in the second line card 508. A FEA can be provided configured to interoperate with an associated REA (described above) as the forwarding engine component 206 interoperates with the routing engine component 510 to determine a network interface of a path to a destination node for transmitting a packet. A FEA provides distributed operation of the forwarding engine component 206 by offloading the work of the forwarding engine component 206 and reducing traffic flow between the line cards and the general processing unit 512. A FEA can operate, as indicated above, with a REA for evaluating a policy and/or performing a routing table lookup in a line card of a received packet. If a network interface for transmitting the packet is identified, the general processing unit 512 and its components need not be involved in identifying the network interface. A line card, in these cases, plays the role of a general processing unit hosting its own FEA and REA.

As described above, in a hierarchical-based routing system a packet with a particular address is routed to a routing node higher in the node hierarchy when the node is in a leaf or subtree below the routing node. Routing can be based on a policy and/or a routing table. No resolution of a name to a portion of a network address is required when a sending node determines that the destination node is not in a leaf node in its hierarchy. In a hierarchical naming system mapped to a hierarchical routing system based on network addresses a name in the naming hierarchy can have all nodes in the domain identified by the name in the same subtree of the routing hierarchy. When a name corresponding to a portion of a network address of a destination node is not in a local naming domain of a sending/routing node, the node can route the packet to a parent node in the network hierarchy without resolving the name in the packet to its corresponding portion of the destination network address.

Returning to FIG. 1, in block 108 the packet is transmitted via the determined network interface to a next node in the network path to the destination node. Accordingly, a system for incrementally resolving a host name to a network address includes means for transmitting the packet via the determined network interface to a next node in the network path to the destination node. For example, as illustrated in FIG. 2, a network interface component 208 is configured to transmit the packet via the determined network interface to a next node in the network path to the destination node.

The forwarding engine component 206 provides for the packet to be received by the determined network interface, such as the second network interface 208. The determined network interface 208 is configured to transmit the packet for delivery to a next node in the network path to the destination node. The transmitted packet includes at least a portion of the information in the received packet. For example, information in a header or trailer of the received packet can be altered such that the determined portion of the network address corresponding to the name is included in the packet. According to an aspect, the name can be removed from the transmitted packet. Further, the payload of the received packet can be divided into portions each sent in a respective packet generated based on the received packet according to the configuration of the path node. Alternatively or additionally, at least a portion of the payload can be combined with at least a portion of a payload from another message, such as a previous or subsequent packet to the destination node.

As described above, FIG. 3 and FIG. 4 illustrate the network interface 208 adapter for operation in the execution environment 302 provided by, for example, the sending node 404 (a path node). The network interface 208 of the path node 402 is configured to transmit the packet for delivery to a next node, such as the second path node 418 in the network path, such as the path 450 to the destination node 406. The packet detector component 202 can be configured to perform the operation of a packet generator and generate the packet including the name corresponding to the portion of the network address as described above. The packet detector component 202 can generate the packet based on data and network identifier of the destination node 406 including the name corresponding to the portion of the network address. The packet detector component 202 can receive routing information identifying a network interface, such as the network interface 208 for transmitting the packet.

The network interface 208, as illustrated in FIG. 3, can include the link layer 318 providing support for a link layer protocol such as IEEE 802.2, 802.3, and/or a wireless link layer protocol. The link layer is operatively coupled to the NIC 320 as illustrated. The NIC 320 can provide at least a portion of the link layer 318 and supports a protocol of a physical media coupled to the NIC 320 compatible with a link layer protocol. The physical media can be connected via a wired or wireless connection and can be included in an internet, such as the Internet and/or an intranet. The network interface 208 is configured to transmit the packet to a next node. The next node can be the first path node 402 or a node included in the path 250A from the sending node 404 to the first path node 402. The next node can be a gateway node and/or a border node of a portion of the network 408 identified by a portion of a network identifier portion of the network address of the destination node 406.

FIG. 3 illustrates a packet detector component 202 can be configured to generate the packet including the name corresponding to a portion of the network address. A portion of the packet detector component 202 is configured to receive the generated packet and receive routing information identifying the network interface 208 to transmit the packet. The packet detector component 202 can be further configured to provide the packet to the link layer 318 included in the network interface 208. The link layer 318 can prepare the packet for transmission by physical medium operatively coupled to the NIC 320. For example, an Ethernet NIC can be included in the network interface 208 illustrated in FIG. 3. The Ethernet NIC can include a hardware adapter for coupling to an Ethernet Local Area Network (LAN). An exemplary Ethernet NIC can include firmware implementing a portion of the link layer 318 and hardware components performing operations on the physical medium or to the physical medium.

A remaining portion of the link layer 318 can be provided as a software driver providing an interface from the NIC 320 to other components operating in the execution environment 302. Other configurations of the link layer 318 and the NIC 320 can be provided that support both wired and wireless physical media and a variety of link layer protocols. The link layer 318 can be configured to generate one or more link layer frames including the packet or a portion of the packet. Each link layer frame can be provided to the physical layer for transmission.

The forwarding engine component 206 illustrated in FIG. 5 can interoperate with a switch interconnect unit 524 to provide a communication channel from the first line card 506 to a line card, such as the second line card 508 including the determined network interface, such as the second network interface 208. Each line card can include a switch interface (SI) for writing packet data to a channel in the switch interconnect unit 524 and/or for reading packet data from the channel. A first switch interface 526 is illustrated in the first line card 506 and a second switch interface 528 is illustrated in the second line card 508, each operatively coupled to the switch interconnect unit 524.

A FEA, such as the first FEA 520, can identify the network interface, the second network interface 208, for transmitting the packet. The first SI 526 of the first line card 506 can setup a channel for communicating the packet to the second SI 528 of the second line card 508. The second SI 528 can read the packet data and provide the packet data to the identified second network interface 208 for transmitting. A FEA, which can interoperate with an associated REA, can be configured to modify the transmission of the packet based on a policy and/or routing table information stored in the including line card. For example, the second FEA 522 interoperating with the second REA 518 can alter a path including a next hop to be traversed by the packet prior to providing the packet to the second network interface 208 for transmitting. The second FEA 522 can determine yet another network interface for transmitting the packet, can interoperate with the forwarding engine component 206 to determine another network interface, or can confirm the network interface identified by the first FEA 520 and/or the forwarding engine component 206.

In another aspect, routing a packet can include discarding the packet. A receiving device can discard a packet by providing it to a line card with a null network interface. In another aspect, routing the packet includes determining a position in a queue associated with the identified network interface based on determined routing information including priority information. A network interface can have one or more queues for queuing packets for transmitting in an orderly fashion. A priority can be associated with a packet for determining a queue and/or a position in a queue for placing the packet for transmitting by the network interface.

The switch interconnect unit 524 illustrated in FIG. 5 can include any medium suitably configured for communication between the line cards and at least a portion of other components operating in the execution environment 502. Various switch fabrics and/or various physical bus media and bus protocols are known to those skilled in the art that are suitable and within the scope of this description.

It should be understood that the various system components (and means) defined by the claims and illustrated in the various block diagrams represent logical components that are configured to perform the functionality described herein. While at least one of these components are implemented at least partially as an electronic hardware component, and therefore constitutes a machine, the other components may be implemented in software, hardware, or a combination of the two. More particularly, at least one component defined by the claims is implemented at least partially as an electronic hardware component, such as an instruction execution machine (e.g., a processor-based or processor-containing machine) and/or as specialized circuits or circuitry (e.g., discrete logic gates interconnected to perform a specialized function). Other components may be implemented in software, hardware, or a combination of the two. Moreover, some or all of these other components may be combined, some may be omitted altogether, and additional components can be added while still achieving the functionality described herein. Thus, the subject matter described herein can be embodied in many different variations, and all such variations are contemplated to be within the scope of what is claimed.

To facilitate an understanding of the subject matter described above, many aspects are described in terms of sequences of actions. At least one of these aspects defined by the claims is performed by an electronic hardware component. For example, it will be recognized that the various actions can be performed by specialized circuits or circuitry, by program instructions being executed by one or more processors, or by a combination of both. The description herein of any sequence of actions is not intended to imply that the specific order described for performing that sequence must be followed. All methods described herein can be performed in any suitable order unless otherwise indicated herein or otherwise clearly contradicted by context.

Moreover, the methods described herein can be embodied in executable instructions stored in a computer readable medium for use by or in connection with an instruction execution machine, apparatus, or device, such as a computer-based or processor-containing machine, apparatus, or device. As used here, a “computer-readable medium” can include one or more of any suitable media for storing the executable instructions of a computer program in one or more of an electronic, magnetic, optical, and electromagnetic, such that the instruction execution machine, system, apparatus, or device can read (or fetch) the instructions from the computer readable medium and execute the instructions for carrying out the described methods. A non-exhaustive list of conventional exemplary computer readable medium includes: a portable computer diskette; a random access memory (RAM); a read only memory (ROM); an erasable programmable read only memory (EPROM or Flash memory); optical storage devices, including a portable compact disc (CD), a portable digital video disc (DVD), a high definition DVD (HD-DVD™), a Blu-ray™ disc; and the like.

The use of the terms “a” and “an” and “the” and similar referents in the context of describing the subject matter (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illuminate the subject matter and does not pose a limitation on the scope of the subject matter unless otherwise claimed. No language in the specification should be construed as indicating any non-claimed element as essential to the practice of the invention as claimed.

Preferred embodiments are described herein, including the best mode known to the inventor for carrying out the claimed subject matter. Of course, variations of those preferred embodiments will become apparent to those of ordinary skill in the art upon reading the foregoing description. The inventor expects skilled artisans to employ such variations as appropriate, and the inventor intends for the claimed subject matter to be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

What is claimed is:

1. A method for incrementally resolving a host name to a network address, the method comprising:
receiving, by a path node in a network path to a destination node, a packet including a name corresponding to a portion of a network address;
determining the portion of the network address corresponding to the name;
determining, based on the portion of the network address, a network interface of the path node; and
transmitting the packet via the determined network interface to a next node in the network path to the destination node,
wherein at least one of the preceding actions is performed on at least one electronic hardware component.

2. The method of claim 1 wherein the network address is an internet protocol (IP) address and the name corresponds to a hierarchical portion of the internet protocol address.

3. The method of claim 1 wherein the packet includes a first header including type bits indicating that a name is included in the packet.

4. The method of claim 3 wherein the packet includes a name header including the name.

5. The method of claim 3 wherein the packet includes a payload area including the name.

6. The method of claim 1 further comprising detecting the name in the packet; and
in response to detecting the name, identifying the position of the corresponding portion of the network address within the network address.

7. The method of claim 6 wherein detecting the name in the packet is based on a packet schema.

8. The method of claim 1 wherein determining the portion of the network address corresponding to the name includes querying a network directory service node configured to resolve the name to the portion of the network address.

9. The method of claim 8 wherein the network directory service node represents at least a portion of a domain identified by the name, when the name is a root domain portion of a network directory service name.

10. The method of claim 1 wherein determining a network interface is based on at least one of a routing policy and a routing table.

11. The method of claim 1 wherein the name is a geospatial name identifying a name geospatial region.

12. The method of claim 11 wherein the geospatial name is associated with a domain having a corresponding domain geospatial region at least partially present in the name geospatial region.

13. A system for incrementally resolving a host name to a network address, the system comprising:
means for receiving, by a path node in a network path to a destination node, a packet including a name corresponding to a portion of a network address;
means for determining the portion of the network address corresponding to the name;
means for determining a network interface of the path node based on the portion of the network address; and
means for transmitting the packet via the determined network interface to a next node in the network path to the destination node,
wherein at least one of the means includes at least one electronic hardware component.

14. A system for incrementally resolving a host name to a network address, the system comprising system components including:
a packet detector component, in a path node in a network path to a destination node, configured to receive a packet including a name corresponding to a portion of a network address;
a resolver component configured to determine the portion of the network address corresponding to the name;
a forwarding engine component configured to determine a network interface of the path node based on the portion of the network address; and
a network interface component configured to transmit the packet via the determined network interface to a next node in the network path to the destination node,
wherein at least one of the system components includes at least one electronic hardware component.

15. The system of claim 14 wherein the network address is an internet protocol (IP) address and the name corresponds to a hierarchical portion of the internet protocol address.

16. The system of claim 14 wherein the packet detector component is configured to receive the packet including a first header including type bits indicating that a name is included in the packet.

17. The system of claim 16 wherein the packet detector component is configured to receive the packet including a name header including the name.

18. The system of claim 16 wherein the packet detector component is configured to receive the packet including a payload area including the name.

19. The system of claim 14 wherein the resolver component is configured to detect the name in the packet, and, in response to detecting the name, identify the position of the corresponding portion of the network address within the network address.

20. The system of claim 19 wherein the resolver component is configured to detect the name in the packet based on a packet schema.

21. The system of claim 14 wherein the resolver component is configured to query a network directory service node configured to resolve the name to the portion of the network address.

22. The system of claim 21 wherein the network directory service node represents at least a portion of a domain identified by the name, when the name is a root domain portion of a network directory service name.

23. The system of claim 14 wherein the forwarding engine component is configured to determine a network interface is based on at least one of a routing policy and a routing table.

24. The system of claim 14 wherein the name is a geospatial name identifying a name geospatial region.

25. The system of claim 24 wherein the geospatial name is associated with a domain having a corresponding domain geospatial region at least partially present in the name geospatial region.

26. A computer readable medium storing a computer program, executable by a machine, for incrementally resolving a host name to a network address, the computer program comprising executable instructions for:
receiving, by a path node in a network path to a destination node, a packet including a name corresponding to a portion of a network address;
determining the portion of the network address corresponding to the name;
determining a network interface of the path node based on the portion of the network address; and
transmitting the packet via the determined network interface to a next node in the network path to the destination node.
